(19) United States
(12) Patent Application Publication
(10) Pub. No.: US 2006/0263750 A1
(43) Pub. Date: Nov. 23, 2006

(54) Personal nutrition control devices

(76) Inventor: Roni Gordon, Doar-Na-Emek Soreq (IL)

Correspondence Address: Martin Moynihan;PRTSI Inc, P O Box 16446, Arlington, VA, 22215, US

(21) Appl. No.: 10/553,257

(22) PCT Filed: Jun. 1, 2005
(86) PCT No.: PCT/IL05/00576

§ 371 Date: Oct. 11, 2005

Related U.S. Application Data
(60) Provisional application No. 60/575,371, filed on Jun. 1, 2004.
(60) Provisional application No. 60/583,601, filed on Jun. 30, 2004.
(60) Provisional application No. 60/638,416, filed on Dec. 27, 2004.
(60) Provisional application No. 60/649,081, filed on Feb. 3, 2005.

(51) Int. Cl. G09B 19/00

(52) U.S. Cl. 434/127

(57) ABSTRACT

The present invention provides portioning and weighing devices, as well as other compositions, that make it much easier for individuals to monitor and control their caloric intake.

### FIELD AND BACKGROUND OF THE INVENTION

The present invention relates to the field of nutrition control systems and more particularly to devices and other compositions conducive for a highly flexible, personally directed nutrition control system. Such a nutrition control system allows an individual/family unit to plan, monitor, control, document, record and learn the appropriate nutritional intake.

One of the most prevalent health problems in the Western World and especially in the United States is excessive body weight, which has become epidemic. Indeed, more than 65 percent of the adult population of the U. S. suffers from this problem.

Accordingly, developing and maintaining a physically fit and healthy body is becoming the goal of an increasing number of individuals. Lately, the public has become increasingly aware of the importance of a proper diet for weight control as well as for health maintenance and disease prevention. As a result, many diets have been designed to lose weight, to maintain present weight, or to assure the consumption of appropriate nutrition.

A large segment of the population is on a special diet at any given time. According to the American Obesity Association, it is estimated that 40% of the women and 25% of the men of the United States are on a special diet for the purpose of weight control. Unfortunately, most dieters fail to achieve their goals for a number of reasons. First, many diets have numerous different and often conflicting guidelines that are presented in a complex manner so that it is often difficult for a person to understand and carry out the diet correctly. A second reason is the often sparse, rigid or monotonous nature of the nutritional regimen prescribed. Self-deprivation is not a well developed trait in modern society.

A third reason is that most diets do not address the need for the dieter to understand the underlying principles of the diet so that he can effectively maintain personally appropriate eating habits after the diet period has ended. A fourth reason that most dieters fail to achieve their goals is they do not know how many calories they require to maintain their weight accordingly to their individual metabolism and, moreover, they cannot conveniently monitor how many calories they consume.

The bottom line with respect to all weight control diets is the need to limit calories. With very few exceptions (such as, for example, serious illnesses), the only way by which a person loses weight is by consuming less calories than is required by the body metabolism to support the required energy level. When fewer calories are consumed, the body metabolizes stored body fat, resulting in weight loss. Conversely, when too many calories are consumed, the body stores this excess energy source as body fat, resulting in weight gain.

It will be appreciated that the above description is somewhat simplified. Not only are calories important, it is also important to obtain the calories from foods that provide proper nutrition to the body. The body has a broad range of nutritional needs in order to maintain health and full function. Accordingly, a person who simply counts calories will not achieve the goal of developing and maintaining a physically fit and healthy body since being concerned with calories to the exclusion of all other factors will not provide proper nutrition.

It is known that a balanced diet includes food from several food groups in order to provide optimum levels of nutrients such as protein, carbohydrates, fats, fiber vitamins and minerals.

Accordingly, the prior art teaches many meal planning aids to assist dieters to consume a diet with proper macro and micronutrient balance. One such aid is disclosed in U.S. Pat. No. 3,681,857 to Yardley which consists of a device which includes preprinted strips attached to a board which indicate the quantity of the different food items consumed and their nutrient value. Another is disclosed in U.S. Pat. No. 4,310,316 to Thomann which is a diet control device consisting of tickets, vouchers and containers, color coded according to lists of foods and categories of foods. Further prior art diet aids include those disclosed in U.S. Pat. No. 4,652,241 to McCarty which employs a device with movable members in display zones representing predefined food groups and portions; and in U.S. Pat. No. 4,606,555 to Adams which uses a set of booklets and cards as a diet control device.

Although considerable effort is represented by the prior art with regard to administering dietary meal plans, the results have not been satisfactory due to the need for ongoing record keeping and oversight. Indeed, in most cases the procedures involved are cumbersome, time consuming, and inconvenient to carry out.

Another well-known diet management system, known generally as an “exchange diet”, divides food into six groups or “exchanges.” The original exchange diet, developed for diabetics and now used by anyone wishing to control or lose weight, is more specifically discussed in the booklet entitled “Exchange List For Meal Planning,” prepared by the American Diabetes Association, Inc. and the American Dietetic Association. According to such exchange diets, food groups are referred to as exchanges, such as bread exchanges, meat exchanges, fat exchanges, fruit exchanges, milk exchanges, and vegetable exchanges. The “exchange” is a unit of food which may be different for each food group. However, within a particular food group each exchange is approximately equal in calories and in the amount of certain nutrients such as carbohydrates, proteins, fats, fiber minerals and vitamins. For each food group, an “exchange list” is provided which sets forth the amount of a specific food that constitutes an exchange. For example, in the above-identified booklet, a small apple and one-fourth of a cantaloupe melon is one fruit exchange.

The exchange diet further specifies the number of exchanges for each food group for a specified daily caloric intake. For example, for a daily two thousand calorie intake, a person is allowed nine bread exchanges, nine meat exchanges, four fat exchanges, six fruit exchanges, three milk exchanges, and two vegetable exchanges.

As can be seen, exchange diets require time and careful attention to carry out properly. A person observing an exchange diet must (a) determine the number of exchanges allowed for each food group, (b) keep track of the number of exchanges consumed in each food group, and (c) keep track of the number of exchanges remaining in each food group. Such information is typically processed and maintained by memory, by notes, or by predetermined menus. Experience has shown that these procedures are both time-consuming and prone to error.

Moreover, an individual on an exchange diet will not achieve the ability to make wise nutritional choices and substitutions across food groups, while remaining within a fixed caloric budget. For example, such an individual will not possess the tools to exchange a fruit with a vegetable.

In order to address this deficiency of exchange diets, aids have been developed to assist the dieter. One such aid is the mechanized management system disclosed in U.S. Pat. No. 3,841,260 to Sharp. The system includes a sheet with an array of holes aligned in columns and rows representing the six different food groups. Color coded pegs, representing one exchange for the food group identified by the color of the peg, are inserted into the holes at appropriate locations. The system includes listings of foods in each food group and the number of exchanges permitted for each group for certain calorie intake limits. This system appears to be bulky and not readily carried by the user.

Another device to assist with the implementation of exchange diets is disclosed in U.S. Pat. No. 4,625,675 to Rosenberg which is a hand-held and portable manipulatable device with a housing, slide members, a numerical display and card inserts. A further attempt is disclosed in U.S. Pat. No. 4,689,019 to Tilney, which is a meal planning kit for adhering to a predetermined diet, primarily for diabetics. The kit contains color coordinated cards to match food groups, and self adhesive stickers for affixing to the cards.

While the above described devices and systems provide for orderly and systematic monitoring of exchange limits and exchanges consumed, they are all awkward and cumbersome to use on a daily basis.

A further well-known method of managing a diet consists of pre-prepared and pre-packaged dietetic food. Indeed, supermarket shelves and freezers are full of such foods. Such dietetic food is often prepackaged into meals that provide well balanced nutrition with limited calories. However, they do not provide any guidance to the dieter for building nor adhering to a structured diet. Moreover, nothing prevents a hungry dieter from eating half a dozen of such meals each day or, for that matter, at a sitting.

Attempts have been made to structure a system of prepackaged meals into an ongoing diet. U.S. Pat. No. 6,039,989 to Bangs provides a system of prepackaged meals for treatment of diet-responsive conditions and U.S. Pat. No. 6,102,706 to Khoo discloses a compliance support system consisting principally of prepackaged meals. As these systems demonstrate, the problem of planning and maintaining a healthful diet goes beyond weight control concerns and exists with respect to other special diets such as those associated with diet-responsive health conditions like cardiovascular disease, diabetes, hypercholesterolemia, hyperglycemia, osteoporosis, cancer and many others, and those required for individuals with special sensitivities or allergies, or diets required by athletes.

There are some advantages to such systems, as the variety of foods within the prepackaged meals enhances ongoing compliance with the diet and there is very little preparation or cooking to do. However, such meals and such systems that utilize such meals have a number of disadvantages, such as denying the dieter the option of selecting the components of each meal, not providing the dieter with the tools nor the knowledge to understand what he is consuming, not facilitating the dieter's ability to carry on healthy eating habits after ending the diet, and not providing any means for monitoring or oversight of compliance. Moreover, while some pre-packaged foods follow the “guidelines daily amounts” of 2000 calories per day for a woman and 2500 calories per day for a man, these numbers are far too general and may mislead the individual consumer.

Rhee (U.S. Pat. No. 6,572,904) describes a method of packing food products, where the calories of each section of food is indicated. Vogel (U.S. Pat. No. 5,402,679) describes a vessel for monitoring the caloric equivalence for fluids. However, neither of these patents describes or even suggests, for example, a uniform system. In particular, neither describes a second (different) type of food having about the same pre-determined content of at least one nutritional component, such as calories.

Similarly, LUNA™ offers a line of bars, many with the same or close caloric content (as indicated) as well as about the same ingredients. However, this line of bars is merely the same weight of the same food with different flavors. It does not teach or suggest a nutritional system, as discussed above.

There is thus a widely recognized need for, and it would be highly advantageous to have, a nutrition control system that does not suffer the above described drawbacks.

The present invention relates to the field of nutrition control systems and more particularly to devices designed to allow a subject to monitor food consumption by measuring and providing food in calorie-based units.

One of the most prevalent health problems in the Western World and especially in the United States is that of excessive body weight. Overweight is epidemic, with more than 65 percent of the adult population of the U. S. suffering therefrom.

As of late, the public has become increasingly aware of the importance of a proper diet for weight control as well as for health maintenance and disease prevention. According to the American Obesity Association, it is estimated that at any given moment, 40% of women and 25% of men in the United States are on a special diet for the purpose of weight control. Even among those who are not overweight, increasing numbers attempt to monitor their daily food intake in order to maintain their current weight or to improve their health and well-being.

The bottom line with respect to weight control, is the need to limit calories. When fewer calories are consumed, the body metabolizes stored body fat, resulting in weight loss. Conversely, when too many calories are consumed, the body stores this excess energy source as body fat, resulting in weight gain. Unfortunately, most subjects find it difficult in practice to monitor their calorie consumption and maintain a balanced diet as an ongoing lifestyle.

Food packages display a variety of data relating to the packaged food. Additional information is often displayed in labels located on or near the product's allotted shelf-space. For example, the amount of food in the package is stated, customarily in units of weight or volume. Macro and micronutrient content is stated per weight or volume unit (e.g. per 100 g, per fluid ounce), or per serving, where the serving size is defined in weight or volume units (e.g. per a 30 g serving of cornflakes with half a cup of skim milk or per package, wherein it is a single serving package). Price is stated per package, per total package weight, and/or per weight or volume unit.

This type of labeling makes it difficult for consumers who wish to eat within the framework of a nutritional budget to make informed, quick and simple comparisons between food options. For example, servings are not entities that it is reasonable to sum, i.e., it is not reasonable to set a daily “serving” budget (e.g. 20 servings per day). Consequently, for a subject trying to maintain a nutritional budget, comparing the nutritional content of a serving of cornflakes and a serving of yogurt is not a fruitful task. Likewise, it is not reasonable to set a daily food budget in weight units (e.g. 1 kg of food per day), and therefore it is not a fruitful task for a subject to compare the nutritional content of 50 g cornflakes and 50 g yogurt Furthermore, since some foods are measured in weight units and others in volume units, summing is not only unfruitful but also often impossible.

Similarly, food portioning devices, such as cutting machines, or scales are currently designed to be weight or volume controlled and, therefore, further requires the individual to perform such calculations.

More specifically, price computing scales can accept as input a portion of food and the food's code. From this information, such devices can produce (by digital display or print) the portion's weight and price. Such devices can also accumulate portion prices to arrive at a total price. They can be further integrated with other devices such as wrapping machines, size reduction machines (e.g., slicers, shredders, dicers, and the like) label printers or cash registers. But such devices remain deficient in assisting individuals with weight control because these devices are based on the weight of the food and not its calories.

Thus, there remains an acute need to assist individuals in losing, or maintaining (or even increasing) their weight. The present invention satisfies this need and provides additional advantages as well.

### SUMMARY OF THE INVENTION

The present invention provides devices and other compositions that make it much easier for individuals to monitor and control their calorie intake.

According to one aspect of the present invention there is provided portioning devices, such as cutting machines, which are calorie oriented. In other words, such machines or devices can provide portions of food based on the number of calories desired. Preferably, calories are provided in round numbers, such as 50 or 100.

According to another aspect of the present invention, there is provided a weighing device such as a scale. Such a scale, which can measure the weight of the food, can provide the caloric content of the food being weighed. Such information can be provided on a display or printed. Preferably, such a scale can also provide the price of the food. Preferably, such a scale is integrated with or connected to a printer, which can print a label with the caloric and other information about the food. The device can provide the caloric content per food portion or slice, or the entire amount, which can be printed on a label.

Another aspect provides labels or tables, which can be in print or electronic format. These labels or tables provide a piece of information about a food, such as food in a package or other enclosure, both per serving and per package. Preferably, this information is the caloric content of the serving and package. More preferably, the caloric content of the serving is not the same amount as the caloric content of the package. Even more preferably, the label or table includes a reference unit of a substantially uniform number of calories, so that such number can be compared to other substantially uniform numbers. Yet more preferably, such number is round, for example, 50, 100, 150, 200 or 250 calories. Yet more preferably, such reference number will be only one of these round numbers.

Another aspect of the invention provides a plurality of labels or tables. These plurality labels or tables provide pieces of information about a plurality of different foods, such as foods in a package or other enclosure. Preferably, this information is the caloric content of the serving and package. Even more preferably, this information is a substantially uniform and, preferably, round, number of calories, most preferably 50 or 100. Yet more preferably, additional nutritional information is provided per calorie.

A further aspect of the invention provides a method of reporting the content of a food product per a pre-determined approximate number of calories or Centicals (“Centical” defined as 100 calories). More preferably, the number of calories is substantially uniform. The content can include both nutritional and non-nutritional information, including weight, price (total and per pre-determined number of calories) fats (saturated and unsaturated), protein, carbohydrates, vitamins, minerals, etc. The pre-determined number of calories is preferably in multiples of 50 or 100, for example, 50, 100, 150, 200, 250, 300, 350, 400, 450, 500, 600, 750 or 1000. Preferably, the pre-determined number of calories per food product is different than the number of calories per serving. More preferably, it is 10, 20, 30, 40, 50, 70, 100 or more calories. Alternatively, it is 10%, 20%, 30%, 40%, 50%, 75%, 100% or more calories.

A further aspect of the invention provides a food product and packaging material that packages the food product. The packaging material displays the the nutritional content of a food product per a pre-determined approximate number of calories or Centicals. The content can include weight, price (including price per pre-determined number of calories) fats (saturated and unsaturated), protein, carbohydrates, vitamins, minerals, etc. The pre-determined number of calories is preferably in multiples of 50 or 100, for example, 50, 100, 150, 200, 250, 300, 350, 400, 450, 500, 600, 750 or 1000. Preferably, the pre-determined number of calories per food product is greater than the number of calories per serving. More preferably, it is 20, 30, 40, 50, 70, 100 or more calories. Alternatively, it is 50%, 75%, 100% or more calories.

As used herein the term “about” or “approximate,” such as in the amount of calories in a serving or package of food, refers to ±10% or ±9 calories, whichever is greater in calories.

According to features in the described preferred embodiments the calorie content is about 100 calories, which is a Centical.

According to features in the described preferred embodiments the foods described herein are selected from the group consisting of natural foods, processed foods and drinks.

According to features in the described preferred embodiments the foods are processed to extend shelf life.

According to features in the described preferred embodiments each of the packages is marked in a specific manner that identifies it with an assembly which comprises similarly marked packages.

According to features in the described preferred embodiments each of the food packages contains a marker which provides information about at least one substantially uniform nutritional component. Preferably, the nutritional component is calories.

According to features in the described preferred embodiments the label, or selective information thereof, as referred to herein is removably affixable.

According to features in the described preferred embodiments the plurality of food packages is prepackaged in a container.

According to features in the described preferred embodiments the plurality of food packages is displayed on a display, including for example, on the internet.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 shows an example macro and micronutrient content and weight stated relative to a serving defined in caloric units, where such units are not a multiple of 100.

FIG. 2 shows an example macro and micronutrient content and weight stated relative to a serving defined in caloric units, where such units are a multiple of 100.

FIG. 3 shows an example macro and micronutrient content and weight per container, where the leading message is the total caloric content of the package.

FIG. 4 shows an example macro and micronutrient content and weight stated relative to a serving defined in Centical (100 calorie) units.

FIG. 5 shows an example macro and micronutrient content and weight per container, where the leading message is the total caloric content of the package in Centicals.

FIG. 6 shows an example macro and micronutrient content, weight and price as stated both relative to a serving defined in caloric units (not a multiple of 100) and per 100 calories.

FIG. 7 shows an example macro and micronutrient content, weight and price as stated both relative to a serving defined in Centicals (not a multiple of 100) and per Centical.

FIG. 8 shows an example macro and micronutrient content, weight, price and calories from fat/carbohydrate/protein as stated both relative to a serving defined in caloric units (not a multiple of 100) and per 100 calories.

FIG. 9 shows an example macro and micronutrient content, weight, price and calories from fat/carbohydrate/protein as stated both relative to a serving defined in calories (not a multiple of 100) and per Centical.

FIG. 10 shows an example macro and micronutrient content, weight, price and Centicals from fat/carbohydrate/protein as stated both relative to a serving defined in Centicals (not a multiple of 100) and per Centical.

FIG. 11A shows the current display of a food; FIG. 11B shows the weight per. 100 calories as well as the total calories of the food; FIG. 11C shows the calories per 100 gram, as well as the total calories (rounded); FIG. 11D shows the price per 100 calories, as well as the total calories.

FIG. 12A shows the price per 100 calories, as well as the total calories (rounded); FIG. 12B shows the price per Centical and total Centicals (rounded); FIG. 12C shows the calories per U.S. dollar and the total calories; FIG. 12D shows the calories per U.S. dollar and the total calories (rounded).

FIG. 13A shows a display regarding food given in weight, weight per predetermined number of calories (preferably 100, as shown), total calories and total price; FIG. 13B shows a display regarding food given in weight, weight per predetermined number of calories (preferably 100, as shown), rounded total calories and total price; FIG. 13C shows a display regarding food given in weight, weight per Centical, total Centicals and total price; FIG. 13D shows a display regarding food given in weight, price per weight unit, calories per weight unit, total calories and total price; FIG. 13E shows a display regarding food given in weight, price per predetermined calorie unit (100 calories as shown), weight per predetermined calorie unit, total calories and total price; FIG. 13F shows a display regarding food given in weight, price per predetermined calorie unit (1 Centical, as shown), weight per predetermined calorie unit (1 Centical, as shown), total calories and total price

FIGS. 14A-D are similar to FIGS. 13A-F, except they are adapted to the Centical method and, therefore, the total calories are in round numbers (here 250 calories or 2.5 Centicals).

FIGS. 15A-C are black box diagrams: FIG. 15A—a portioning device (1) accessing (2) its internal software or the store's ERP (3); FIG. 15B a scale (4) accessing (5) its internal software or the store's ERP (6); FIG. 15C a scale (7) integrated (8) with a size reduction machine (9), label printer (10) or cash register (11), all of which can access (12) their internal software or the store's ERP (13).

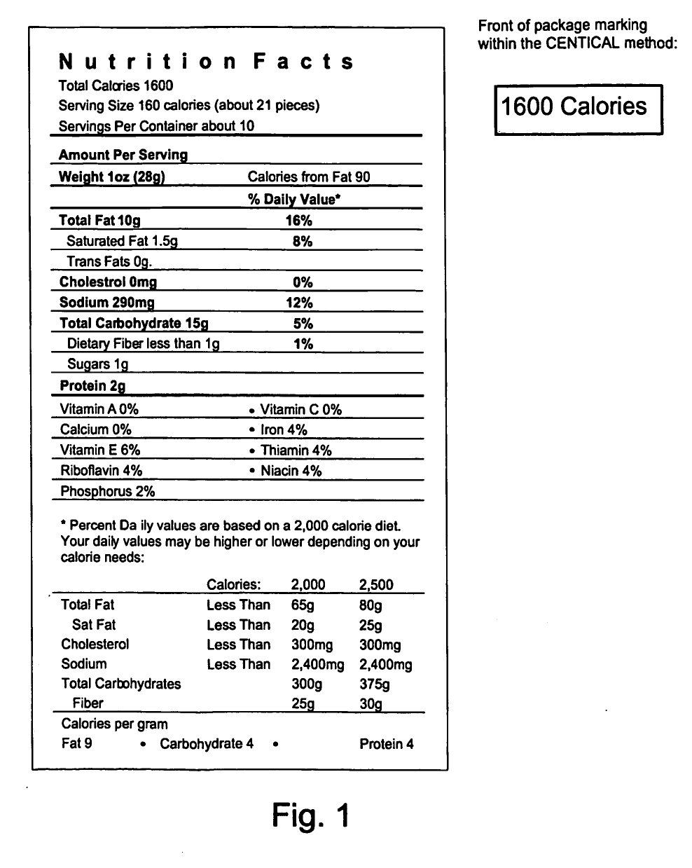

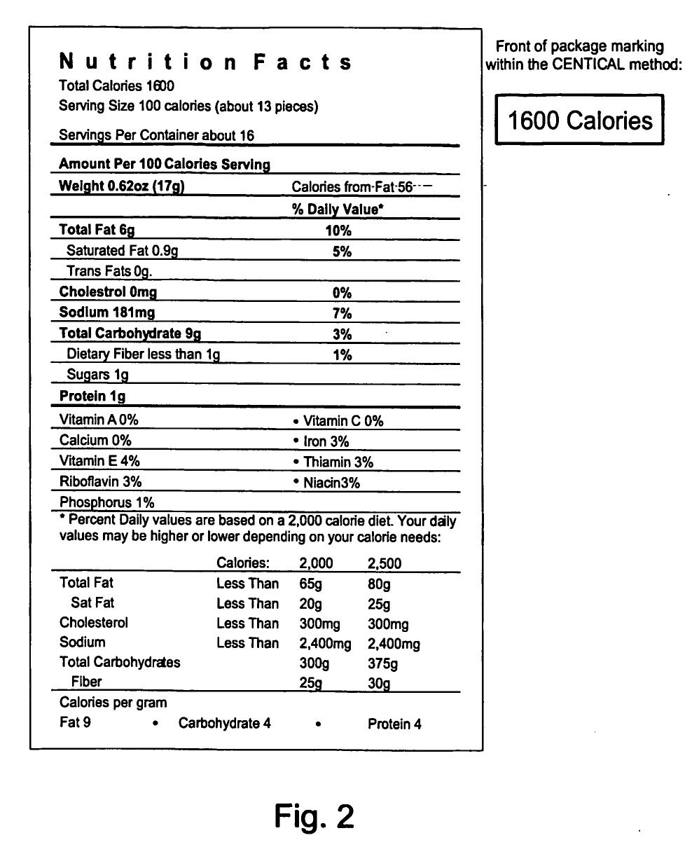

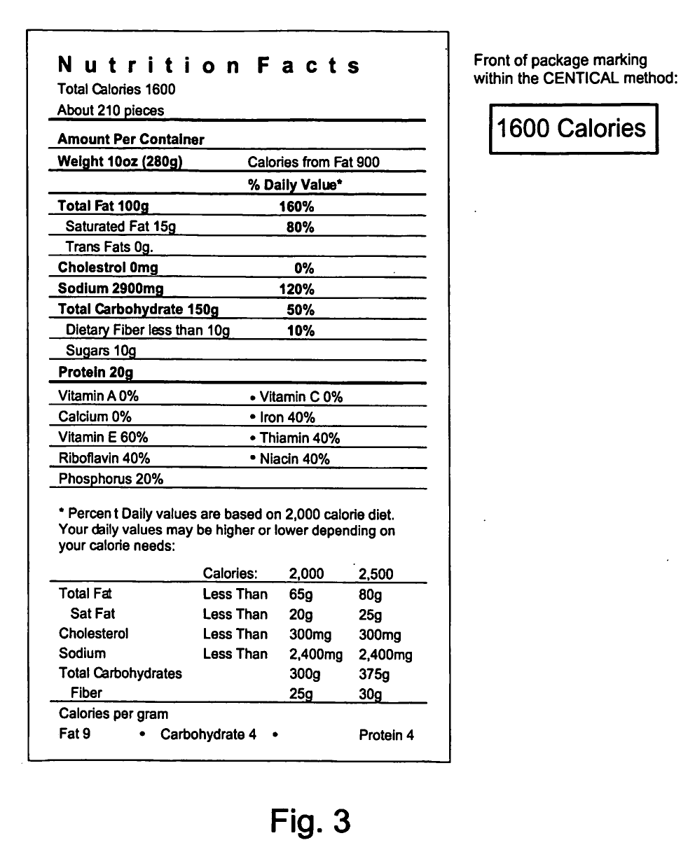

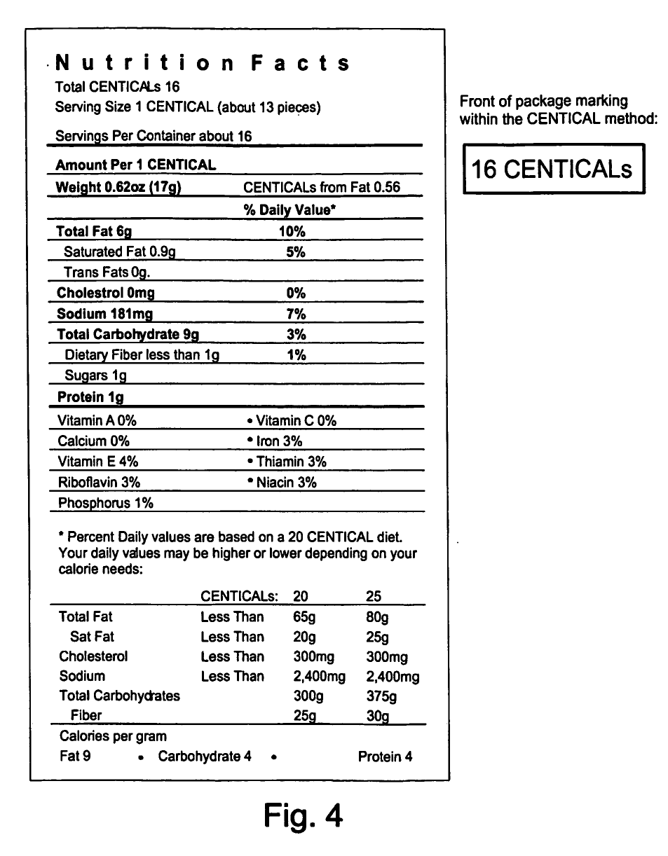

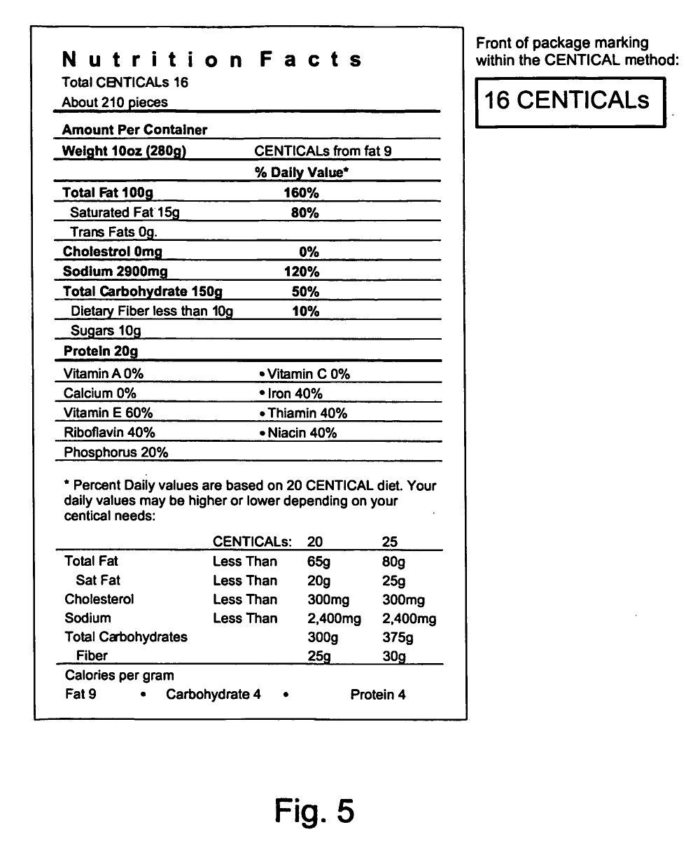

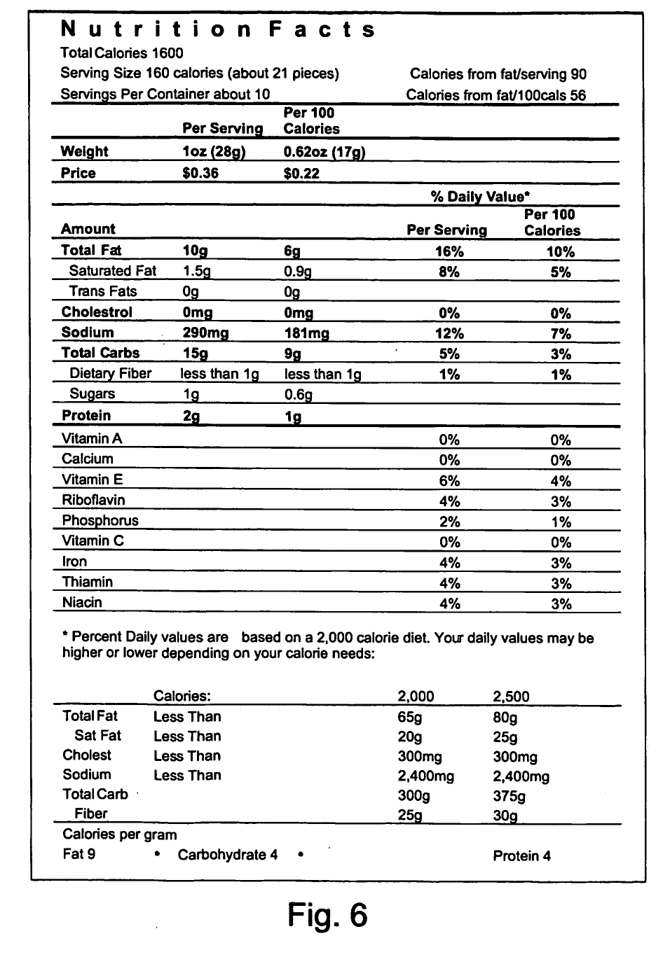

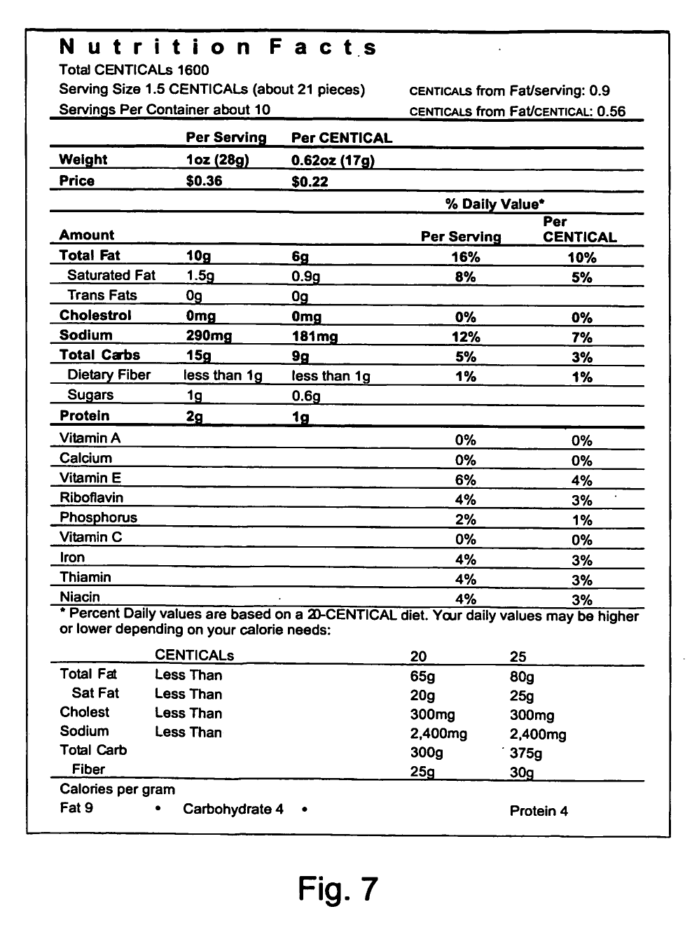

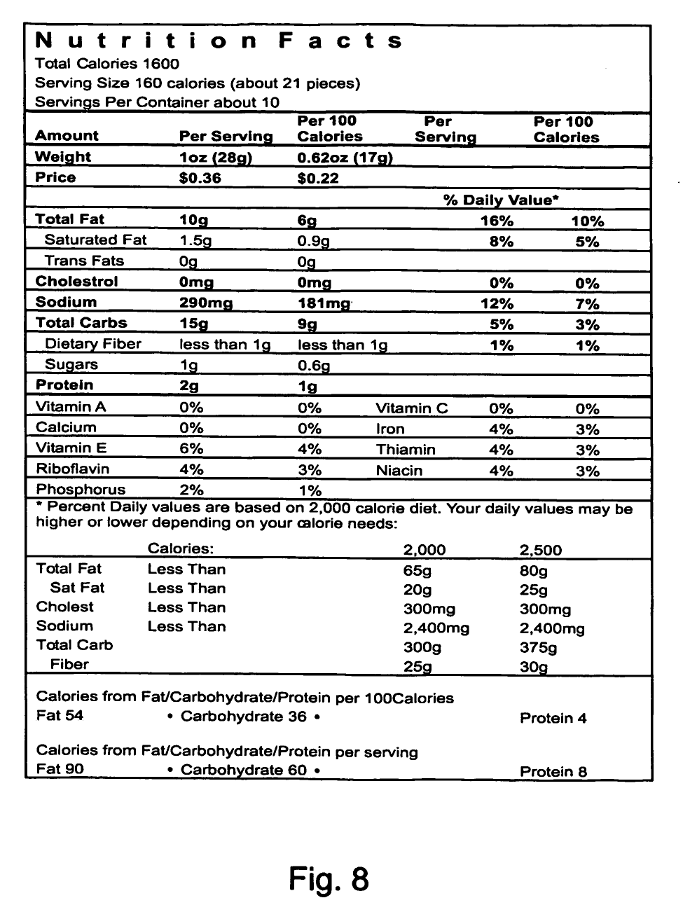

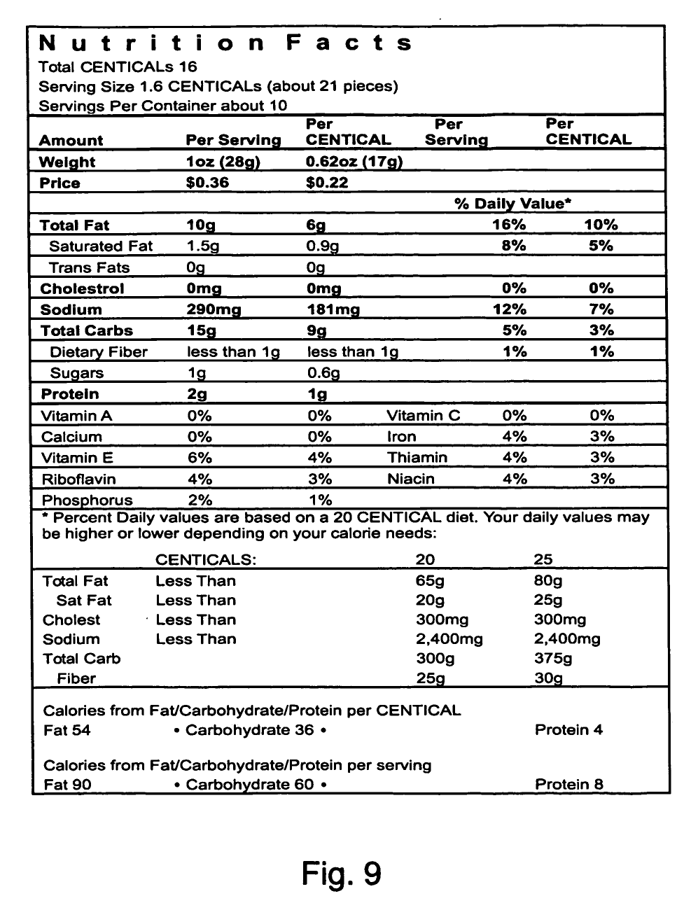

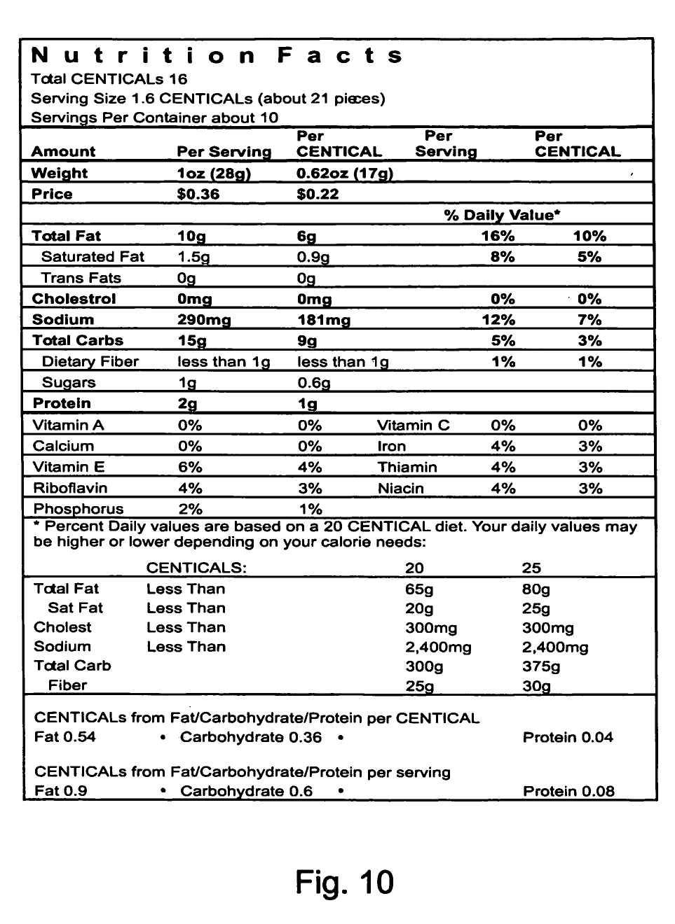

### DESCRIPTION OF THE PREFERRED EMBODIMENTS

The present invention relates to devices that allow the planning, controlling and monitoring nutrition consumption which is highly flexible and allows an individual to vary the foods being eaten without having to measure the quantities of the foods and calculate the calories therein. The present invention further relates to displays and labels similarly conducive.

The principles and operation of the devices and labels of the present invention may be better understood with reference to the drawings and accompanying descriptions.

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Underlying the present invention is the belief that information should stated relative to the nutritional units that are used to define a nutritional budget, the ideal reference unit for this information being the calorie or Centical (100 calorie unit).

Calorie/CENTICAL-focused labeling caters to the needs of subjects who maintain a daily caloric budget, which is the most natural type of nutritional budget to use. First, calories are the common denominator of all foods and it is therefore feasible to sum total calorie consumption. Second, whereas it makes no nutritional sense to sum servings or grams eaten per day, it does make sense to sum the calories consumed. Third, it is commonly accepted that limiting caloric intake is a key, if not the key, to weight control. Experts and regulatory authorities are increasingly emphasizing the need for maintaining a caloric budget.

A given caloric amount can provide different types of benefits—(a) health benefits such as intake of required macro and micronutrients; (b) satiety benefits, i.e. how full we feel after consuming this amount of calories, generally related to the weight/calories ratio that characterizes the food; (c) pleasure benefits, i.e., how much pleasure we derive from consuming this amount of calories from this particular product (for example many consumers would derive more pleasure from 100 calories of chocolate than from 100 calories of cabbage); (d) convenience benefits, i.e., how easy is it for us to obtain and prepare this amount of calories from this particular food product (e.g. 100 calories of takeaway sushi are more convenient than 100 calories of salad prepared at home; and (e) price benefits, i.e., how expensive is it for us to obtain this amount of calories from this particular food product, relative to other options with the same caloric content.

Different consumers value the various benefits differently. Some care more about nutrition, some care more about taste. But all weight-conscious consumers will want to maximize the value of the calories they consume on one or more of the scales above. In order to do so consumers must have the relevant cost and benefit information. Taste and convenience benefits are obvious. But for nutrition, satiating effect and price, consumers must receive the appropriate information in a format that will facilitate fruitful comparisons.

An individual who maintains a caloric budget will often want to optimize the nutritional content of the food consumed within the budget. In other words, within a caloric budget, it makes sense to compare the nutritional value of different foods relative to their caloric “cost”. For example, whereas a subject may eat a 500-calorie lunch comprised entirely of chocolate, nutritional considerations will favor eating a 300-calorie chicken breast sandwich and a 200-calorie salad.

Stating nutritional information relative to a caloric reference unit will allow consumers to make an informed, quick and simple comparison based one or more nutritional components among different foods and across the range of various food groups, maximizing the nutritional value of the calories they consume. Nutritional information in this respect includes, but is not limited to, macro and micronutrient content. According to the present invention, in addition to or instead of stating a food's macro and micronutrient content per 100 g or per serving or per container defined in weight or volume units, macro and micronutrient content may be stated per the total number of calories in the package, per pre-measured individual portion where the portion is defined in calorie units, per recommended or pre-measured serving where the serving is defined in calorie units, per 100 calories or per Centical.

The new Dietary Guidelines for Americans, published on Jan. 12, 2005, provide a striking example of why such a calorie-focused labeling system is needed. According to the Guidelines, most Americans should eat fewer calories, be more active, and make wiser food choices within calorie needs. In particular, meeting nutrient recommendations must go hand in hand with keeping calories under control. The guidelines therefore recommend consuming nutrient-dense foods and beverages—those that provide substantial amounts of vitamins and minerals and relatively few calories—maximizing the health benefits of the foods consumed while keeping the total within the energy needs.

However, when it comes to giving specific advice, the Dietary Guidelines fail to implement their own theory. Throughout the report, the nutrient and calorie content tables, meant to guide Americans in making wise food choices, state nutritional information relative to the “standard amounts” defined in weight/volume units. As discussed above, this type of labeling does not provide the means for straightforward comparisons of nutrient densities. Only calorie-focused labeling according to the. Centical approach would provide the information that the Guidelines themselves deem relevant.

For example, the Dietary Guidelines recommend sweet potato as the No. 1 food choice for potassium: a serving of Sweet Potato (one sweet potato, 146 g) contains 694 mg of potassium, while a serving of beet greens (½ cup) contains only 655 mg, and a serving of cooked Spinach (½ cup) contains only 419 mg. However, converting this information to straightforward nutrient-density units (e.g. stating the nutrient content per 100 calories), it becomes apparent that beet greens and spinach are far better choices than sweet potato as sources for potassium: beet greens contain 3447 mg of potassium per 100 calories, cooked spinach contains 1995 mg of potassium per 100 calories, while sweet potato contains only 530 mg potassium per 100 calories. Clearly this is the relevant information to use when trying to maximize the benefits of the calories consumed.

Other, non-nutritional information in this respect includes, but is not limited to weight, volume, or price. Thus weight, volume or price may be stated per the total number of calories in the package, per pre-measured individual portion where the portion is defined in calorie units, per recommended or pre-measured serving where the serving is defined in calorie units, per 100 calories or per Centical.

Stating the weight per caloric unit (e.g., 50 g/Centical), for example, provides a measure of “energy-density.” To some people, energy density, i.e., how much energy a food contains in relation to its weight, or inversely, how much a food weighs in relation to its caloric content, may be more important than the total amount of energy a food has. Energy density relates to how satiating, or filling, a food is. For example, a large candy bar, which weighs 100 grams, may contain more calories than a meal of sirloin steak served with potatoes and broccoli, having a total weight of 400 grams. Thus, its high energy-density means that the large candy bar has a disproportionately high calorie content relative to its satiating effect. An individual maintaining a caloric budget will want to compare the relative satiating effects of different types of food that have the same caloric costs. For example, when seeking to optimize the satiating effect of a 5-Centical lunch, an individual may prefer a meal of Chicken Breast, Broccoli and Baked Potato with a weight of 100 g/Centical (500 g/5 Centicals) over meal of Hamburger (without the bun) and French Fries with a weight of 35 g/Centical (175 g/5 Centicals), as the energy-density of the second option is 3 times higher than the energy density of the first option.

The Centical unit can also be used as reference unit for pricing. Instead of (or in addition to) stating the price per weight or volume unit, price may be stated per 100 calories or Centical. This information may be used, for example, in price-computing scales, as discussed below.

More specifically, the present invention contemplates a wide-scale shift to calorie-focus in the food universe requires the use of supportive devices and infrastructure. At present, devices used in the manufacturing, processing, measuring or selling of food are weight or volume-focused. They accept input in weight or volume units, or rely on weight/volume information for calculations, or provide output in weight/volume units. The present invention focuses on the idea that these devices need to be adapted to use caloric units (calories or Centicals) as input, output or in the intermediate stages of operation, instead of or in addition to the weight/volume units that are currently used. Such calorie-based devices are useful, for example, in supermarkets, for handling foods that are packed, measured and priced at the retail outlet itself rather than by the manufacturer (e.g. bulk foods, fruit and vegetables, foods sold at counters).

As used herein, the term “food” refers to any natural, processed or otherwise produced solid or liquid comestible that is customarily eaten for the purpose of introducing digestible or non-digestible material into the gastrointestinal tract.

As used herein, the term “different food” or “different types of food” are foods whose weight per serving differ (as indicated on the label). For purposes of clarity and example, the same types of food in different flavors, but with the same fat percentage, (e.g., a) 150 g of 3% fat yogurt with generally different flavors or different fruit; or b) 1 ounce granola bars with different flavors) are not “different foods.” By contrast, two milks with different fat percentages are “different foods,” as they require different weights to have the same caloric content.

Preferably, a line of “different foods” are foods whose calories per serving differ from least to most by more than 9 calories. Also preferably, “different foods” can have the same weight per serving but differ in their major (e.g. three largest) ingredients.

As used herein, the term “nutritional component” refers to macronutrients, micronutrients, non-digestible materials and any other quantifiable component, element or characteristic of a comestible substance, including, but not limited to, calories, carbohydrates, sugars, fats, saturated fats, cholesterol, fiber, proteins, amino acids, minerals and vitamins. It also includes non-nutritional components such as price weight and volume.

As used herein, the term “personal nutrition” refers to the content and quantity of food, apportioned and packaged into single portions having a predetermined and substantially uniform nutritional component value that is consumed in a predetermined time period.

The present invention provides devices and other compositions designed to make it easier for individuals to monitor and control their calorie intake.

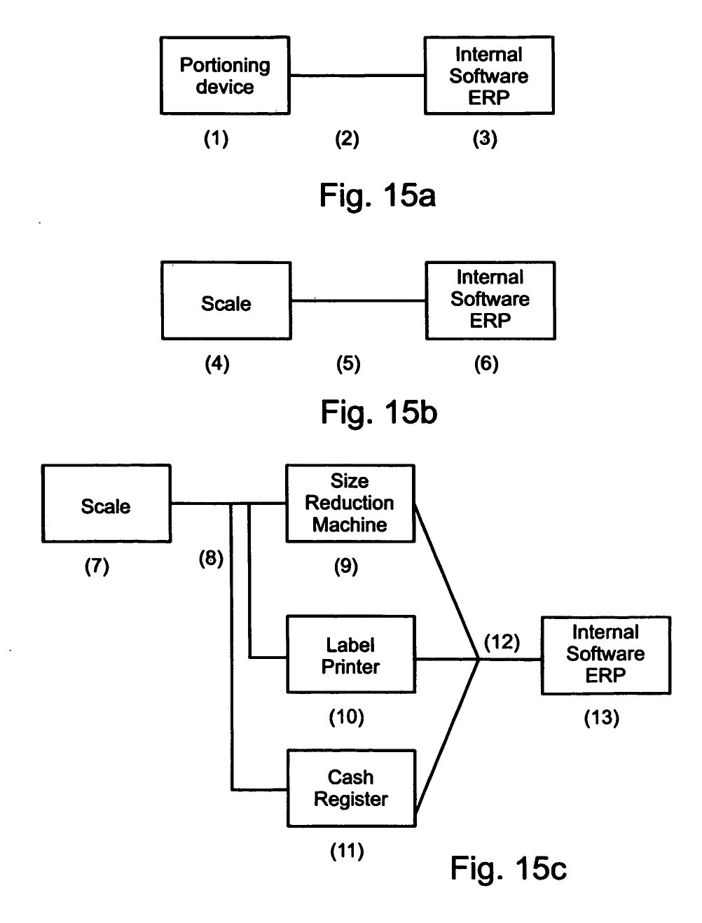

According to one aspect of the present invention there is provided portioning devices (1), such as cutting machines, which are calorie oriented. In other words, such machines or devices can provide portions of food based on the number of calories desired. Such devices are adapted to accept as input a portion size that is defined in calories or Centicals. Such devices are used for any type of food, such as cheese, fruit, vegetables, poultry, meat, fish, bread, potato chips, French fries, and the like. Thus, for example, such devices (1) can have the weight of the food converted into calories or Centicals (2) by using the conversion table accessed by the device's internal software or the store's “ERP” (enterprise resource planning software) (3). See FIG. 15A. SAP is a major producer and distributor or ERP software.

Included in such devices (1) are those that sort food, such as fruit and vegetables, by passing them through holes of different sizes. The size can then converted to weight (2) (using the conversion table accessed by the device's internal software or the store's “ERP” (enterprise resource planning software) (3). SAP is a major producer and distributor or ERP software. The device can then calculate how many units of each size should be in the package to produce the desired total weight.

According to the present invention, this device (1) can accept the desired total caloric content of the package and, accessing (2) the conversion table or ERP (3) described above, can produce the portion or portions needed to result in the calorie-based portions and/or total caloric content. Preferably, calories are provided in round numbers, such as 100, 150, 200, 250, 300, 350, 400, 500, 1000, etc. Preferably, the portions can be in non-round numbers that accumulate to a round number or in round numbers. For example, fruit and vegetables (and other produce) are often in non-round units, but accumulate to round numbers, in contrast to, for instance, processed foods.

Product-specific weights can also be adapted by the device of the invention to portion a specific product into predetermined calorie-based portions. For example, a bakery may use dough weights to divide a large quantity of dough into 150 gram portions for buns and 600 gram portions for loaves. According to the present invention, the portioning device can measure the portions in calorie units, preferably multiples of 50 or 100. Thus, dough measuring at 2 Centicals for 150 grams can be used to portion the dough into 2 Centical buns.

According to another aspect of the present invention, there is provided a scale (4). Such a scale can, for example, provide nutritional and non-nutritional information per a pre-determined number of calories, for example, weight, volume, fat content, etc.

A scale of the invention also includes those that can compute prices. Price computing scales (4) can accept as input a portion of food and the food's code. The device can then produce an output (via display or print) the portion's weight and price. To calculate the food's price, the device can access (5) a table (in its internal software or the store's ERP) (6) to find the food's price per unit weight, and then multiply this number by the weight on the scale. See FIG. 15B. In addition, the device can add portion prices to arrive at the total price. Such devices (7) can further be integrated (8) with other devices, such as size reduction machines (for example, slicers, shredders, dicers, etc.) (9), label printers (10) or cash registers (11).

According to the present invention, such devices (4) can be adapted (5) to produce as out put the caloric content of the food being weighed by accesses the internal software of the device or the ERP of the store (6). See FIG. 15B. More specifically, this can be implemented by adding weight-calorie conversions to the table used by the device (either internally or as part of the store's ERP). Such devices (7) can further add the caloric content of two or more packages and, optionally, be integrated (8) with other devices, such as size reduction machines (for example, slicers, shredders, dicers, etc.) (9), label printers (10) or cash registers (11), as described above. These integrated devices (9, 10, 11) can also access (12) and display caloric-based information by using their internal software or the store's ERP (13). See FIG. 15C.

Such caloric information can be provided on a display or printed. Preferably, such a scale can also provide the price of the food. Preferably, such a scale (7) is integrated with or connected to (8) a printer (10), which can print a label with the caloric and other information about the food. The device can provide the caloric content per food portion or slice, which can be printed on a label. More specifically, nutritional and non-nutritional information per pre-determined number of calories can be provided.

Preferably, the portions or total amount of the package are provided in multiples of 50 or 100 calories units or in Centical units.

Similarly, the invention provides a register, such as a cash register, and display or printout produced from it, the display or printout providing each food's caloric content and the total caloric content of the foods being purchased, as outlined above.

Another aspect of the invention provides labels or tables, which can be in print or electronic format. These labels or tables provide a piece of information about a food, such as food in a package or other enclosure, both per serving and per package. Preferably, this information is the caloric content of the serving and package. More preferably, the caloric content of the serving is not the same amount as the caloric content of the package. Even more preferably, the caloric content of the package is 20, 50, 40, 60, 80 or one hundred calories or more than the caloric content of a serving. Most preferably, the content is 50 or 100. Alternatively, the caloric content of the package is a multiple (50%, 100%, 150%, 200%, etc.) of the caloric content of a serving.

In yet another aspect of the invention, there is provided a plurality of labels or tables. These plurality labels or tables provide pieces of information about a plurality of different foods, such as foods in a package or other enclosure. Preferably, this information is the caloric content of the serving and package. More preferably, the caloric content is pre-determined and one or more nutritional ingredients is listed per this pre-determined amount of calories.

Alternatively, such plurality is with respect to two or more foods having different packaged weights and, more preferably, the same calorie amount (or multiples of it) per package. Alternatively, such plurality is with respect to two or more different foods

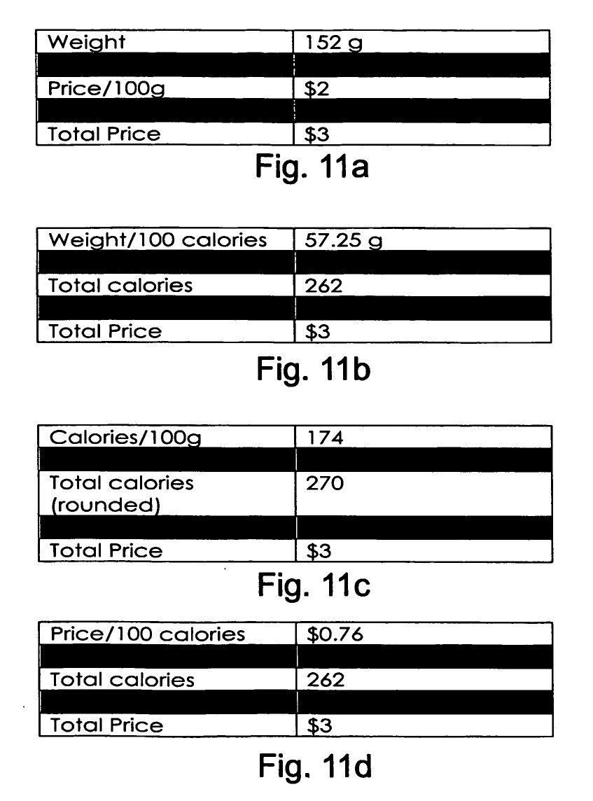

Displays or labels can be in a wide variety of formats. For example, FIG. 11A shows the current display of a food. By contrast, FIG. 11B shows the weight per 100 calories as well as the total calories of the food, FIG. 11C shows the calories per 100 gram, as well as the total calories (rounded) and FIG. 11D shows the price per 100 calories, as well as the total calories.

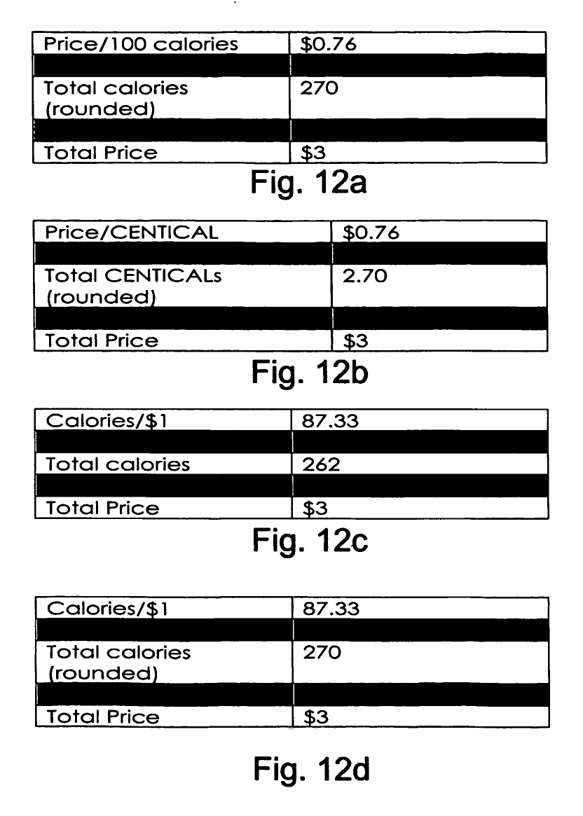

Similarly, FIG. 12A shows the price per 100 calories, as well as the total calories (rounded), FIG. 12B shows the price per Centical and total Centicals (rounded), FIG. 12C shows the calories per U.S. dollar and the total calories and FIG. 12D shows the calories per U.S. dollar and the total calories (rounded).

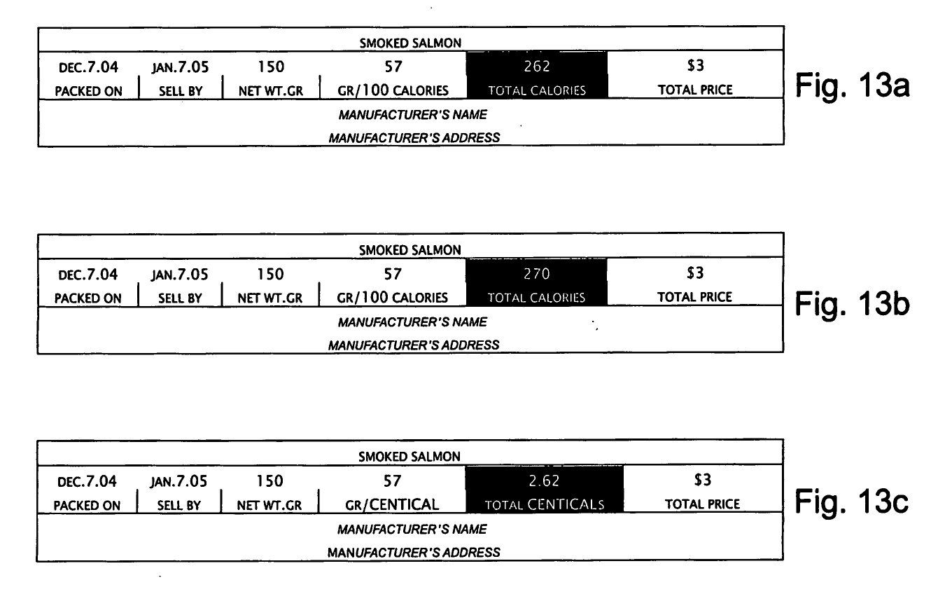

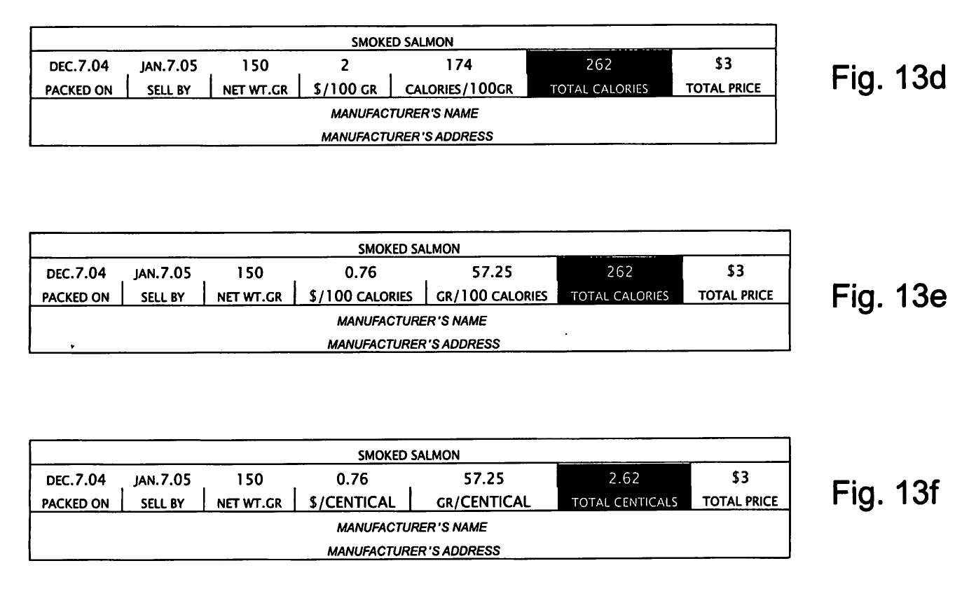

In addition, FIG. 13A shows a display regarding food given in weight, weight per predetermined number of calories (preferably 100, as shown), total calories and total price, FIG. 13B shows a display regarding food given in weight, weight per predetermined number of calories (preferably 100, as shown), rounded total calories and total price, FIG. 13C shows a display regarding food given in weight, weight per Centical, total Centicals and total price, FIG. 13D shows a display regarding food given in weight, price per weight unit, calories per weight unit, total calories and total price, FIG. 13E shows a display regarding food given in weight, price per predetermined calorie unit (100 calories as shown), weight per predetermined calorie unit, total calories and total price and FIG. 13F shows a display regarding food given in weight, price per predetermined calorie unit (1 Centical, as shown), weight per predetermined calorie unit (1 Centical, as shown), total calories and total price

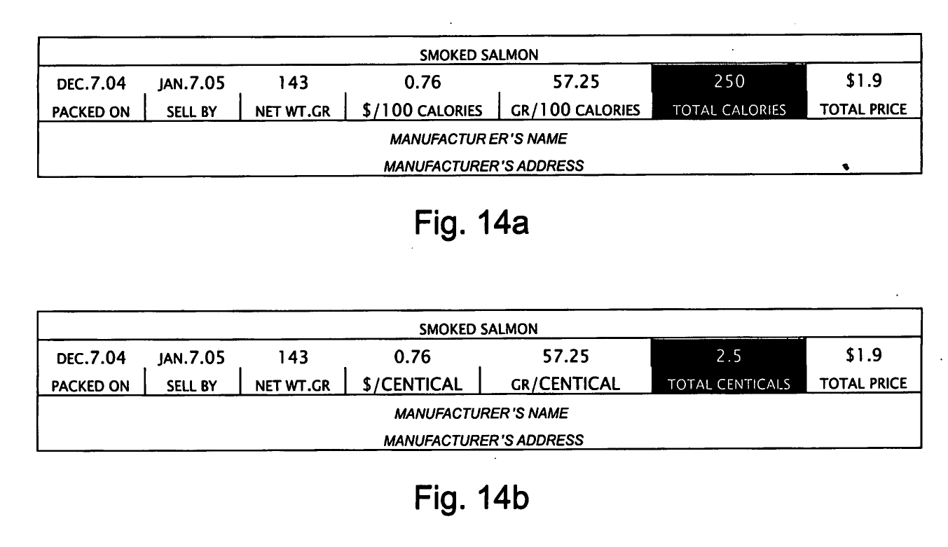

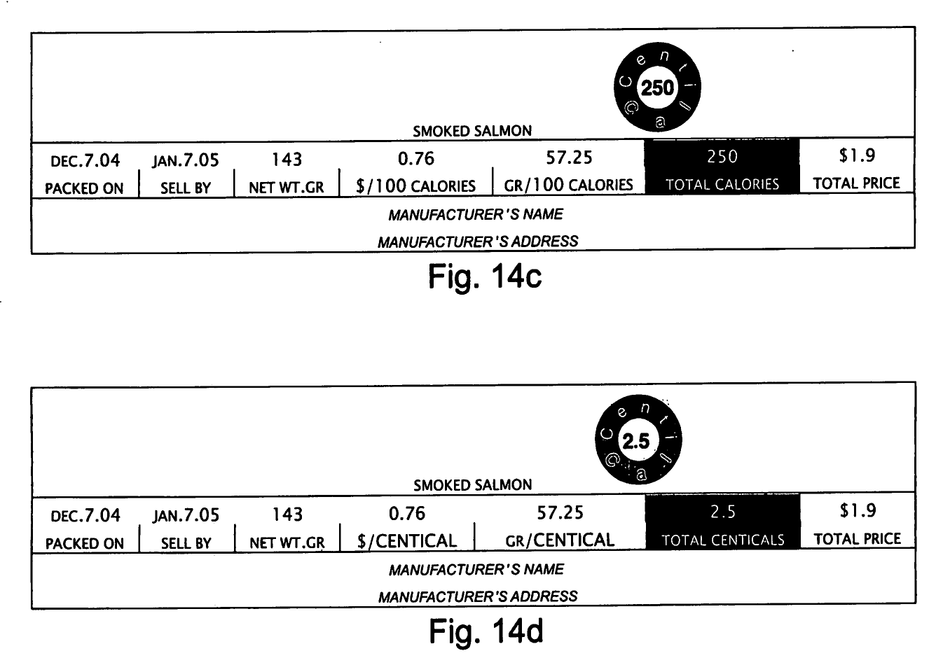

FIGS. 14A-E are similar to FIGS. 13A-F, except they are adapted to the Centical method and, therefore, the total calories are in round numbers (here 250 calories or 2.5 Centicals).

In another aspect of the invention, the labels of the invention, described above, can be color-coded to help individuals watch their caloric intake while following a balanced diet, such as the one provided by the guidelines of the USDA Food Pyramid. So, for example, dairy products can be labeled blue, and meat, poultry, fish, dry beans, eggs and nuts can be labeled red.

The labels can be color-coded, for example, to indicate the level of convenience. For instance, gold can signify the highest convenience level (e.g., products portioned in round 50 or 100 calorie units), and silver can mean that the entire package has a round number of calories but is not portioned, and red can mean that portions are not in round numbers.

A further aspect of the invention provides a method of reporting the nutritional content of a food product per a predetermined approximate number of calories or Centicals. The nutritional content can include weight, fats (saturated and unsaturated), protein, carbohydrates, vitamins, minerals, etc. The pre-determined number of calories is preferably in multiples of 50 or 100, for example, 50, 100, 150, 200, 250, 300, 350, 400, 450, 500, 600, 750 or 1000. Preferably, the pre-determined number of calories per food product is different (more preferably, greater) than the number of calories per serving. More preferably, it is 20, 30, 40, 50, 70, 100 or more calories. Alternatively, it is 50%, 75%, 100% or more calories. Alternatively, the presentation is not per serving unit. Preferably, the pre-determined number of calories is substantially uniform for all packages, and more preferably a round number such as 50, 100 or 200 calories.

A further aspect of the invention provides a food product and packaging material that packages the food product. The packaging material displays the the nutritional content of a food product per a pre-determined approximate number of calories or Centicals. The nutritional content can include weight, fats (saturated and unsaturated), protein, carbohydrates, vitamins, minerals, etc. The pre-determined number of calories is preferably in multiples of 50 or 100, for example, 50, 100, 150, 200, 250, 300, 350, 400, 450, 500, 600, 750 or 1000. Preferably, the pre-determined number of calories per food product is greater than the number of calories per serving. More preferably, it is 20, 30, 40, 50, 70, 100 or more calories. Alternatively, it is 50%, 75%, 100% or more calories. Alternatively, the presentation is not per serving unit.

In addition, other types of information can be selected and displayed to address the needs of specific target populations. For example, food products targeted at the elderly can add statements such as “low sugar” or “low sodium” to the labels of the invention.

It should be understood, that devices and labels adapted to calories, as described above, is merely one aspect of the invention. Such devices and labels can also be adapted to any other aspect of nutrition, such as sodium content, fat content, carbohydrate content, protein content, fiber, vitamins, etc.

The invention also provides a method that provides reporting the caloric content of foods (5, 10, 20, 25, 50, 100 or more foods, or all foods) in a substantially uniform amount of 100 calories. There are many reasons as to why 100 is an advantageous number.

First, because using round numbers is easy. Multiples of 100 are the easiest way to do calorie math, not the only one. One common thread in food marketing is simplicity. Marketers have learned from earlier failed attempts that complicated serving calculations contributed to consumer resistance.

Second, because when we examine on-the-shelf products, 100 calories appears to be the optimal base unit in many types of foods. Many products are already sold in servings that are ±10% from the nearest Cenitcal serving.

Third, because in an industry increasingly centered on snacking and grab-and-go food, 100 calories emerges as the psychologically optimal individual serving size. Studies conducted by the Luna Bar creators showed that women had a 200-calorie threshold when it came to snacking. Kenneth Cooper, MD, MPH, one of the world's foremost experts on health, nutrition and exercise, has developed guidelines for Frito-Lay's new snack products that include a portion cap of 150 calories. On the other hand, products served in portions of up to 50-calorie are identified as dietary and hence less tasty. If 150-200 is the upper threshold for serving sizes and 50 is not attractive, 100 is ideal.

Fourth, all nutritional budgets (defined by gender, age & level of activity) are defined in multiples of 100 calories (e.g. 1200, 1500, 1800, 2000, 2500, 3000). It would therefore be more compliable to make building blocks of 100 calories (and its multiples) than give general recommendations in terms of servings, weight and volume units per 2000 calories diet, with the advice to use a ratio if budget differ. For example, to consume 90% of the food recommended, for 1800 calories budget ( 1800/2000=90%).

Fifth, nutritional information must be prioritized. With obesity on the rise, locating caloric content quickly and easily is of central importance. The only way to make calories the highest priority is to create a calorie-based food currency and, consequently, to make this currency the simplest number possible.

Finally, if the optimal nutritional base unit is 100 calories, converting 100 calories to 1 CENTICAL will ease calculations. Indeed, this system is so simple even pre-school children can use it.

The range of foods, both natural and processed, that may be packaged in package is extremely varied and broad and may include natural and processed foods from all commonly existing food groups, such as bread, baked goods, grains, pasta, rice; vegetables; fruits; milk products, liquid and solid; high protein products such as meat, fish, chicken, beans, eggs and processed proteins; oils, sauces and gravy; snacks such as peanuts, pretzels, potato chips; sweets; beverages such as soft drinks, juice, alcoholic beverages; and more. Each package can be identified with respect to the type of food it contains, preferably both in writing and optionally via an image. Moreover, the foods may be packaged and stored in varying conditions, according to the method of storage and desired preparation method. For example, foods may be packaged after mixing, precooking, freezing, dehydrating, freeze-drying or otherwise treating them for purposes of preservation. Preferably, such foods have a sufficiently long storage or shelf-life that they may be packaged well in advance of consumption. For some foods it is known that storage or shelf-life under retail conditions ranges between nine to twelve months.

It is also understood that the term “package” is extremely broad and includes any food-containing composition on to which a label can be placed. Thus, the term includes any enclosure such as a box, can, or wrapping (such as cellophane or paper), cup, bowl or plate. It can also include a composition that ties the food, such as a rubber band, wire or string.

In addition, the displays of the invention described above can further provide a desired amount of nutrients such as protein, carbohydrates, fats, fiber, vitamins and minerals, to fortify and enhance a diet. It is known that various combinations of macro and micronutrients are desirable to address specific needs in treating and preventing diet-responsive conditions, as well as maintaining general good health.

In particular, such displays may preferably contain vitamins and minerals for which a USRDA has been set by the U.S. food and Drug Administration or by the U.S. Department of Agriculture (USDA), such as Vitamins A, B.sub.1, B.sub.2, B.sub.3, B.sub.6, B.sub.12, C, D, E, and K; and Biotin, Calcium, Copper, Folic Acid, Iodine, Iron, Magnesium, Manganese, Pantothenic Acid, Phosphorus, and Zinc. It is understood that fortification of certain nutritional components may require approval by a governmental regulatory authority, such as the USDA.

Vitamins and minerals, for which a USRDA has been established, are identified in the following table, along with the respective amount.

U.S. Recommended Dietary Allowance (USRDA)

| NUTRIENT | USRDA | |
|---|---|---|
| VITAMIN A | 5000 | IU |
| VITAMIN B₁ | 1.5 | mg |
| VITAMIN B₂ | 1.7 | mg |
| VITAMIN B₃ | 20 | mg NE. sup. 1 |
| VITAMIN B₆ | 2 | mg |
| VITAMIN B₁₂ | 6 | mcg |
| VITAMIN C | 60 | mg |
| VITAMIN D | 400 | IU |
| VITAMIN E | 30 | IU |
| VITAMIN K | NONE ESTABLISHED | |
| BIOTIN | 300 | mcg |
| CALCIUM | 1000 | mg |
| COPPER | 2 | mg |
| FOLIC ACID | 400 | mcg |
| IODINE | 150 | mcg |
| IRON | 18 | mg |
| MAGNESIUM | 400 | mg |
| MANGANESE | NONE ESTABLISHED | |
| PANTOTHENIC ACID | 10 | mg |
| PHOSPHORUS | 1000 | mg |
| ZINC | 15 | mg |

Displays will preferably contain an amount that allows a subject to achieve the USRDA minimum or other designated level of consumption of any particular nutrient by eating a predetermined number of food units per day. As with calories, in order to achieve the USRDA minimum of nutrients, a subject need only count the food units containing the relevant nutrient eaten each day.

A further preferred embodiment is for the devices of the invention to provide a predetermined amount of a nutritional component in order to treat a diet responsive condition. Many conditions are diet responsive. Indeed, there are those who would argue that all physical conditions are diet responsive. Without arguing the validity of the assertion, suffice is to say that there are a number of conditions about which there is no argument that they are diet responsive, similar to obesity and overweight, discussed hereinbefore. Accordingly, the portioning and weighing devices of the invention may preferably be used by a subject who suffers from diabetes, hypercholesterolemia, hyperglycemia and other diseases and conditions. For example, a diet for both medically stabilized and non-medically stabilized diabetes is designed to control plasma glucose and plasma lipid levels and maintain body weight at a level appropriate for the particular patient. Therefore, such a diet will have two components: First, the ADA has recommended that the intake of simple sugars be restricted and that complex carbohydrates be increased for diabetics; and second, the diet will include an appropriate caloric level tailored to a subject's height, weight, age, sex and activity level. Although the indicators associated with diet-responsive diabetes must be specifically determined for each individual patient, a typical 1500 calorie menu prepared by the ADA holds simple sugars to within a range of about 96 to 107 grams from fruits and vegetables. Accordingly, the devices of the invention, which help one monitor and control ones caloric intake, are useful for diabetics as it can be used to control and monitor both sugar intake and calories simultaneously. In addition, the devices of the invention can be adapted to display the amount of simple sugars (or salt, etc.) in a food, as described above.

Subjects suffering from hypercholesterolemia or any form of hyperlipidemia are often instructed to limit fats, particularly polyunsaturated fatty acids, in order to lower total serum cholesterol, triglycerides and LDL. Subjects most likely to achieve reductions in cholesterol and triglyceride levels as a result of dietary control are those without lipid lowering medication that have cholesterol levels in a range of about 220 to 300 mg/dl or triglyceride levels in a range of about 200 to 1000 mg/dl, or both, or those with lipid lowering medication that have cholesterol levels of about 200 to 260 mg/dl or triglyceride levels of about 200 to 1000 mg/dl. By using the devices of the invention, a subject can easily control and monitor the intake of fat in the diet, which may have the added benefit of reducing dependency on lipid lowering medication.

Cancer is another disease about which there is controversy regarding its responsiveness to dietary factors. However, it is acknowledged that certain dietary elements influence the progression of the disease. High dietary fiber, low fat consumption and adherence to daily recommended allowances for certain vitamins and minerals, including vitamins A and C, reduce the risk factors associated with various types of cancers. The devices of the invention can be applied to display these nutritional components.

The present invention provides a number of advantages over existing methods of food building, monitoring and compliance, as follows:
A) It addresses the needs of a growing pull-market that is demanding a convenient, simple and realistic tool for tracking food consumption.
B) It allow for a holistic framework that enables consumers to control their nutritional intake without restricting them to a particular choice of foods.
C) It makes food shopping convenient. Consumers like to see simple, bold claims on products or labels because it helps them make decisions when shopping in a hurry.
D) It is compatible with all diets and diet methods.
E) It can help consumers define a daily calorie budget, which they can use on its own or as a frame of reference to augment their chosen diet method.
F) It is so simple, even pre-school children can use it. It is, therefore, an important tool for early education.
G) It is not difficult to implement, as it does not require major changes either in food product portioning, weighing or labeling, or in food shopping habits.
H) For the consumer, it represents a modest but effective investment in wellness. For food makers, retailers and service providers, it represents a means of passing the responsibility for weight control to the consumer and being perceived as pro-consumer.

The present invention eliminates the difficulty in counting calories, especially as most people are unaware of the caloric content of their foods. Thus the devices of the invention help provide the individual with the means to monitor caloric intake.

As used herein, the term “food” refers to any natural, processed or other solid or liquid comestible that is customarily eaten for the purpose of introducing digestible or non-digestible material into the gastro-intestinal tract.

The range of foods, both natural and processed, is extremely varied and broad and may include natural and processed foods from all commonly existing food groups, such as bread, baked goods, grains, pasta, rice; vegetables; fruits; milk products, liquid and solid; high protein products such as meat, fish, chicken, beans, eggs and processed proteins; oils, sauces and gravy; snacks such as peanuts, pretzels, potato chips; sweets; beverages such as soft drinks, juice, alcoholic beverages; and more. Moreover, the foods may be packaged and stored in varying conditions, according to the method of storage and desired preparation method. For example, foods may be packaged after mixing, precooking, freezing, dehydrating, freeze-drying or otherwise treating them for purposes of preservation. Preferably, such foods should have a sufficiently long storage or shelf-life for them to be packaged well in advance of consumption. For some foods it is known that storage or shelf-life under retail conditions ranges between nine to twelve months.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

What is claimed is:

1. A portioning device that can portion a food based on the number of calories or Centicals of the portion of food.

2. The device of claim 1, wherein the weight of the food is converted to calories or Centicals.

3. The device of claim 2, wherein the conversion is made through the device's internal computer software.

4. The device of claim 2, wherein the conversion is made through ERP.

5. The device of claim 1, wherein a portion with a predetermined number of calories can be provided.

6. The device of claim 5, wherein the desired number of calories is selected from the group consisting of about 50, 100, 150, 200, 250, 300, 350, 400, 450, 500 600, 750 and 1000.

7. The device of claim 1, wherein said device is selected from the group consisting of a cutting machine, shredder and dicer.

8. The device of claim 1, wherein said device is a fruit or vegetable sorting machine.

9. The device of claim 1, wherein the food is selected from the group consisting of cheese, fruit, vegetables, poultry, meat, fish and bread.

10. A weighing device that can display the number of calories or Centicals of a food and wherein a) the device provides nutritional information per pre-determined number of calories or b) can compute the price of the food.

11. The device of claim 10, wherein the weight of the food is converted to calories or Centicals.

12. The device of claim 11, wherein the conversion is made through the device's internal computer software.

13. The device of claim 11, wherein the conversion is made through ERP.

14. The device of claim 10, wherein the device is a price computing scale.

15. The device of claim 14, wherein the device accesses a weight-calorie conversion table.

16. The device of claim 15, wherein the table is accesses through the internal software of the device.

17. The device of claim 15, wherein the table is accesses through ERP.

18. The device of claim 10, wherein the device can add the caloric content of two or more packages of food.

19. The device of claim 10, which is integrated with another device.

20. The device of claim 19, wherein the other device is selected from the group consisting of a wrapping machine, size reduction machine, label printer and cash register.

21. The device of claim 10, wherein the caloric information is printed.

22. The device of claim 10, wherein the calories are in about multiples of 50.

23. The device of claim 10, wherein the device provides nutritional information per pre-determined number of calories.

24. The device of claim 23, wherein the information is price per pre-determined number of calories.

25. The device of claim 23, wherein the information is weight per pre-determined number of calories.

26. A register that provides the price and approximate caloric or Centical content of a food.

27. The register of claim 26, wherein the caloric content is accessed through the internal software of the device.

28. The register of claim 26, wherein the caloric content is accessed through ERP.

29. The register of claim 26, wherein the caloric content is printed.

30. The register of claim 26, wherein it can add the caloric content of two or more packages.

31. The register of claim 26, wherein it can provide the total number of calories of all foods purchased.

32. The register of claim 31, wherein this total number is rounded to either the nearest or higher 50.

33. A display that provides the approximate number of calories of a serving of food and the approximate number of calories of the selected amount of the food, wherein these two approximate numbers are different.

34. The display of claim 33, wherein the caloric content of the package is about 20 or more calories than the caloric content of a serving.

35. The display of claim 33, wherein the caloric content of the package is about 50% or more calories than the caloric content of a serving.

36. The display of claim 33, which is in the form of a table.

37. The display of claim 33, which is printed.

38. The display of claim 37, which is on a label.

39. The display of claim 33, which is in electronic form.

40. Two or more displays that provide nutritional information per substantially uniform caloric content.

41. The displays of claim 40, wherein the substantially uniform caloric content is 50 or 100 calories.

42. The displays of claim 40, wherein at least two of such foods are different types of foods.

43. The displays of claim 40, wherein at least two of such foods have different weights.

44. The displays of claim 40, which are in the form of a table.

45. The displays of claim 40, which are printed.

46. The displays of claim 45, which are on a label.

47. The displays of claim 40, which are in electronic form.

48. A method of reporting the nutritional content of a food product comprising reporting the nutritional content per a predetermined approximate number of calories or Centicals.

49. The method of claim 48, wherein said number is substantially uniform number with the number reported for one or more other foods.

50. The method of claim 49, wherein the substantially uniform number is 50 or 100.

51. The method of claim 48, wherein the number of calories per serving of the food product is not presented.

52. The method of claim 48, wherein the pre-determined approximate number of calories or Centicals is different than the approximate number of calories or Centicals per serving or per weight unit.

53. The method of claim 52, wherein the pre-determined approximate number of calories or Centicals of the food product is 50% or more than the approximate number of calories or Centicals per serving.

54. The method of claim 48, wherein the nutritional content of the food product being reported comprises at least one of the following: the weight, price, fat, saturated fat, unsaturated fat, trans fat, protein, carbohydrate, vitamin and mineral content of the product.

55. The method of claim 48, wherein the pre-determined approximate number of calories is selected from the group consisting of 50, 100, 150, 200, 250, 300, 350, 400, 450, 500, 600, 750 and 1000.

56. A food product and packaging material that packages the food product, the packaging material displaying the nutritional content of a food product per a pre-determined approximate number of calories or Centicals.

57. A plurality of different food products of the food product of claim 56, each having said predetermined approximate number of calories or Centicals.

58. The composition of claim 56, wherein said number is substantially uniform number with the number reported for one or more other food products.

59. The composition of claim 58, wherein said substantially uniform number is 50 or 100.

60. The composition of claim 56, wherein the number of calories per serving of the food product is not displayed.

61. The composition of claim 56, wherein the pre-determined approximate number of calories or Centicals is different than the approximate number of calories or Centicals per serving.

62. The composition of claim 56, wherein the pre-determined approximate number of calories or Centicals of the food product is 50% or more than the approximate number of calories or Centicals per serving.

63. The composition of claim 56, wherein the nutritional content of the food product being reported comprises the weight, price, fat (saturated and unsaturated), protein, carbohydrate, vitamin and mineral content of the product.

64. The composition of claim 56, wherein the pre-determined approximate number of calories is selected from the group consisting of 50, 100, 150, 200, 250, 300, 350, 400, 450, 500, 600, 750 and 1000.
